(19) United States
(12) Patent Application Publication
(10) Pub. No.: US 2004/0098573 A1
(43) Pub. Date: May 20, 2004

(54) Configurable initialization of hardware

(75) Inventors: Tal Hassid, Petah Tikva (IL); Lior Avital, Kfar Saba (IL); Meir Katz, Kfar Saba (IL)

Correspondence Address: Fogg and Associates, LLC, P.O. Box 681339, Minneapolis, MN, 55458-1339, US

(73) Assignee: ADC Telecommunication Israel Ltd.

(21) Appl. No.: 10/298,848

(22) Filed: Nov. 18, 2002

(51) Int. Cl. G06F 15/177

(52) U.S. Cl. 713/1

(57) ABSTRACT

In a family of telecommunications modules or other circuit boards, driver software is divided into a core support package for initializing board components common to the family of circuit boards and one or more extended support packages specific to individual members of the family. This facilitates a reduction in the amount of programming effort needed across the family of circuit boards as the core support package need only be developed once for the family of boards rather than developing complete driver programs for each member of the family. The remaining programming effort can then be focused on the specialized subroutines. In addition, changes in hardware common to each member of the family can be accommodated by redeveloping only the core program. This need only occur once for the entire family, rather than once for each member of the family.

### TECHNICAL FIELD OF THE INVENTION

The present invention relates generally to configurable initialization of processor-based hardware, and in particular to the initialization of a related circuit boards within telecommunication systems.

### BACKGROUND OF THE INVENTION

Modern telecommunication systems are typically modular in design. The systems contain a number of modules for providing various services, service levels and interface types between a service provider and its customers. In this manner, these systems are able to address a variety of customer needs without having to design each system from scratch.

Similar to a personal computer, these various options may be provided by adding electronic circuit boards to the system. Such circuit boards generally have a processor and other electronic components for providing a specific functionality. As with other electronic systems, these circuit boards must be initialized during start-up or reset of the system. During initialization, the board's processor and other board hardware will be reset. The processor will be prepared to communicate with the other board hardware and one or more external devices using a software application often referred to as a device driver. These device drivers are traditionally developed for each board configuration. Development of device drivers for a multitude of circuit boards within a family of circuit boards or modules for a given telecommunications system can be very time intensive.

For the reasons stated above, and for other reasons stated below that will become apparent to those skilled in the art upon reading and understanding the present specification, there is a need in the art for alternative procedures of initializing processor-based hardware.

### SUMMARY

The various embodiments utilize driver software that contains a core support package or driver program for initializing board components common to a family of circuit boards and one or more extended support packages or subroutines specific to individual members of the family. This facilitates a reduction in the amount of programming effort needed across the family of circuit boards as the core support package need only be developed once for the family of boards rather than developing complete driver programs for each member of the family. The remaining programming effort can then be focused on the specialized subroutines. In addition, changes in hardware common to each member of the family can be accommodated by redeveloping only the core program. This need only occur once for the entire family, rather than once for each member of the family. The embodiments of the invention include apparatus and methods of varying scope.

### BRIEF DESCRIPTION OF THE DRAWINGS

FIG. 1 is a simplified block diagram of a circuit board in accordance with an embodiment of the invention.

FIG. 2 is a flowchart of a method of initializing a circuit board in accordance with an embodiment of the invention.

FIG. 3 is a conceptualization of the relationship of core and extended board support in accordance with embodiments of the invention to hardware and the applications operating on that hardware.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, electrical or mechanical changes may be made without departing from the scope of the present invention. The following detailed description is, therefore, not to be taken in a limiting sense, and the scope of the present invention is defined only by the appended claims and equivalents thereof.

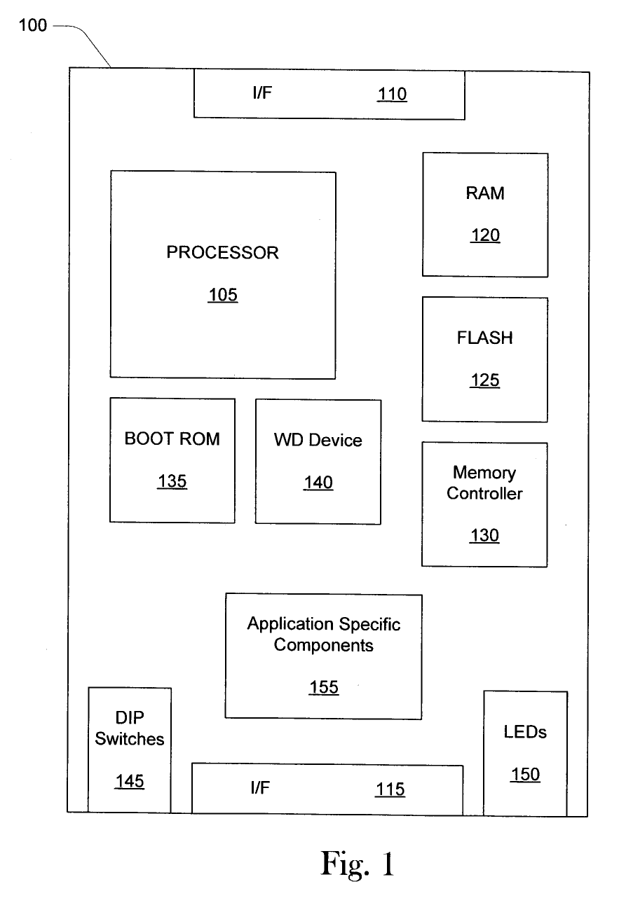

FIG. 1 is a simplified block diagram of a circuit board in accordance with an embodiment of the invention. For one embodiment, the circuit board is a telecommunications module 100. The module 100 includes one or more interfaces 110/115 for communication with other devices (not shown) such as a host computer, a local device or a network device. For one embodiment, communications interface 110 is a management interface for coupling to a backplane of a communications network element and communications interface 115 is a network interface.

The circuit board or module 100 includes a processor 105 for control and operation of the module 100. Computer-usable instructions for operation of the processor 105 are contained in computer-readable media, such as dynamic random-access memory (DRAM) 120, electrically-erasable programmable RAM (EEPROM or Flash) 125 and/or Boot ROM (read-only memory) 135.

In operation of the module 100 of FIG. 1, the processor 105 initializes on power-up or reset and reads the Boot ROM 135 for initialization of basic hardware, such as memory controller 130. Upon initialization of the memory controller 130, the processor 105 is enabled to communicate with other computer-readable media, such as Flash 125. Flash 125 is a programmable nonvolatile memory. Such programmable nonvolatile memory is typically used for storage of software routines used for initialization of processor-based systems.

The Boot ROM 135 typically has a much smaller storage capacity. Because ROM is not considered to be field programmable, it will generally hold software routines used to provide only basic functionality to the processor 105. Further functionality is then provided from computer-readable media that can be updated, often by the end user, such as Flash 125. The module 100 may further include DRAM 120 for volatile storage of current operating parameters and data, computer-usable instructions for the processor 105 transferred from the Flash 125 or other information available to the processor 105 during operation.

Once communication is established between the processor 105 and the Flash 125 or other nonvolatile memory, a first software routine or program is run to initialize one or more components of the module 100 that are common to each member of a family of modules or circuit boards. Some examples may include one or more of the communication interfaces 110/115, a watchdog device 140 for resetting the processor 105 in response to abnormal operation, DIP switches 145 and LEDs 150. Other examples (not shown) may include baud-rate generators, temperature sensors and other components providing functionality that is common across the family. Although these various components may be common to each member of the family, individual members may utilize them differently. Accordingly, for embodiments of the invention, the first program calls subroutines stored in the Flash 125 or other nonvolatile memory to provide specific definitions or service operations for the common components. Examples may include chip select, I/O pine configurations, memory management, baud rate generation, clock routing, etc.

In addition to utilizing common components differently, or in the alternative, individual members of the family may contain one or more application-specific components 155. While some of the components may be contained on more than one type of module 100, for one embodiment the subset of the application-specific components 155 varies for each member of the family. Where the module 100 contains one or more application-specific components 155, the first program calls additional subroutines to provide for initialization of these components. For this embodiment, the additional subroutines are different for each member of the family. For another embodiment, more than one member of the family contains the same subset of application-specific components 155. For this embodiment, the additional subroutines may be the same for the members containing the same subset of application-specific components 155. However, for this embodiment, the first set of subroutines will provide different definitions and service operations to the common components and/or the application-specific components.

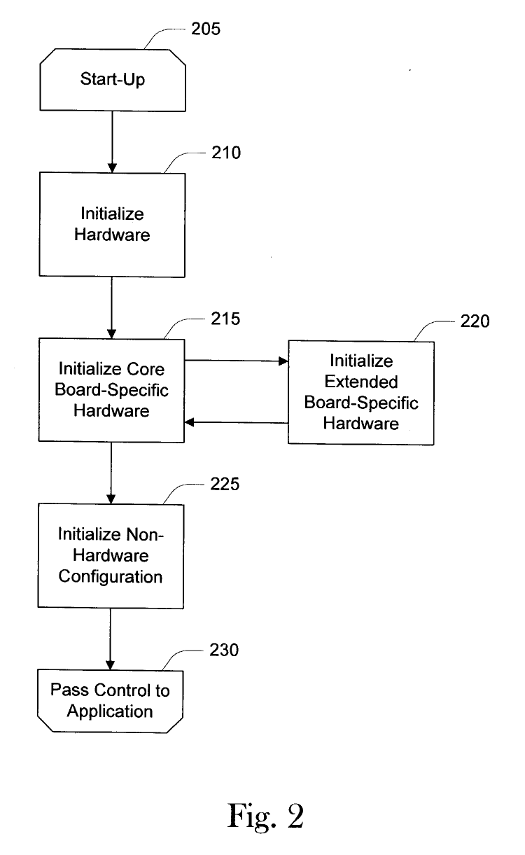

FIG. 2 is a flowchart of a method of initializing a circuit board in accordance with an embodiment of the invention. At 205, the circuit board is in a start-up condition as a result of a power-up, a manual reset, a watchdog-initiated reset or other system reset condition. The basic hardware is initialized at 210. In general, this basic hardware is preferably the minimum required to allow the processor to communicate with components of the circuit board.

Core board-specific hardware is initialized at 215 using a first program or software routine. This initialization provides basic functionality to board components that are common across a family of circuit boards. To provide application-specific functionality to these, common components, the first program calls one or more subroutines at 220 to initialize their extended functionality. In addition, or in the alternative, other subroutines may be called at 220 to initialize application-specific board components. Upon initialization of the board hardware, the board may proceed to initialize non-hardware configurations at 225. As examples, this may include setting up configuration tables in DRAM or other drivers or miscellaneous modules for operation of the circuit board. Control is then turned over to the application for normal operation of the circuit board at 230.

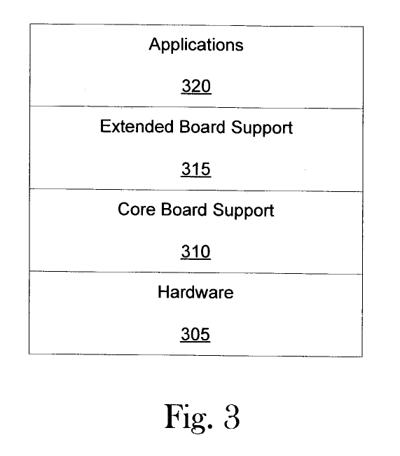

FIG. 3 is a conceptualization of the relationship of core and extended board support in accordance with embodiments of the invention to hardware and the applications operating on that hardware. A board support package facilitates operation of an application 320 on the hardware 305 in a manner that is substantially hardware-independent. The board support package, containing the core board support 310 and the extended board support 315, provides a basic platform for the application and can be adapted to accommodate changes in the hardware 305. For example, as better-performing components become available, these components may be incorporated into the hardware. However, these new components, while providing the same functionality, may have different operating parameters, requiring a different interface between the application 320 and the hardware 305. By modifying the board support package to provide translation between the application and the new hardware, the application may still be usable without modification, despite updating the hardware upon which it runs. By separating the board support into a core component 310 and a collection of subroutines as an extended component 315, a change in hardware common to each member of a family of circuit boards may be handled with modification of only one software routine, i.e., the program calling the board-specific subroutines.

### Conclusion

Various embodiments have been described to utilize driver software that contains a core support package or driver program for initializing board components common to a family of circuit boards and one or more extended support packages or subroutines specific to individual members of the family. This facilitates a reduction in the amount of programming effort needed across the family of circuit boards as the core support package need only be developed once for the family of boards rather than developing complete driver programs for each member of the family. The remaining programming effort can then be focused on the specialized subroutines. In addition, changes in hardware common to each member of the family can be accommodated by redeveloping only the core program. This need only occur once for the entire family, rather than once for each member of the family.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A method of initializing a processor-based circuit board, comprising:
initializing the processor;
running a first program on the processor to initialize a first subset of components of the circuit board; and
calling one or more subroutines from the first program to provide specific definitions and service operations to the first subset of components.

2. The method of claim 1, wherein calling one or more subroutines further initializes a second subset of components of the circuit board.

3. The method of claim 2, wherein the first subset of components is common across a family of circuit boards and the second subset of components is unique to each member of the family.

4. A circuit board, comprising:
a processor;
a first subset of components coupled to the processor;
memory coupled to the processor and having computer-usable instructions contained therein capable of causing the processor to perform a method, the method comprising:
initializing the first subset of components;
calling one or more subroutines to provide definitions to the first subset of components.

5. A method of initializing two related processor-based circuit boards, comprising:
initializing a processor on each circuit board;
running a first program on the processor of a first circuit board to initialize a first subset of components of the first circuit board; and
running the first program on the processor of a second circuit board to initialize a first subset of components of the second circuit board;
calling one or more subroutines from the first program on the processor of the first circuit board to provide specific definitions and service operations to the first subset of components of the first circuit board; and
calling one or more subroutines from the first program on the processor of the second circuit board to provide specific definitions and service operations to the first subset of components of the second circuit board;
wherein the first subset of components of the first circuit board contains the same components as the first subset of components of the second circuit board.

6. The method of claim 5, wherein the first circuit board and the second circuit board have differing functionality.

7. The method of claim 5, wherein calling one or more subroutines further initializes a second subset of components of the associated circuit board.

8. The method of claim 5, further comprising:
wherein calling one or more subroutines from the first program on the processor of the first circuit board further initializes a second subset of components of the first circuit board; and
wherein the second subset of components of the first circuit board contains components not found on the second circuit board.

9. The method of claim 5, further comprising:
wherein calling one or more subroutines from the first program on the processor of the first circuit board further initializes a second subset of components of the first circuit board;
wherein calling one or more subroutines from the first program on the processor of the second circuit board further initializes a second subset of components of the second circuit board; and
wherein the second subset of components of the first circuit board is different than the second subset of components of the second circuit board.

10. A method of initializing two related processor-based circuit boards, comprising:
initializing a processor on each circuit board;
running a first program on the processor of a first circuit board to initialize a first subset of components of the first circuit board; and
running the first program on the processor of a second circuit board to initialize a first subset of components of the second circuit board;
calling one or more subroutines from the first program on the processor of the first circuit board to provide a first functionality to the first circuit board; and
calling one or more subroutines from the first program on the processor of the second circuit board to provide a second functionality to the second circuit board different from the first functionality;
wherein the first subset of components of the first circuit board contains the same components as the first subset of components of the second circuit board.

11. A circuit board, comprising:
a processor;
a first subset of components coupled to the processor;
memory coupled to the processor and having computer-usable instructions contained therein capable of causing the processor to perform a method, the method comprising:
initializing the first subset of components using a first program; and
completing the initialization of the first subset of components by calling a set of subroutines from the first program;
wherein the first subset of components and the first program are common to a family of circuit boards containing the circuit board; and
wherein the set of subroutines is different from at least one other member of the family of circuit boards.

12. The circuit board of claim 11, wherein the method further comprises:
initializing a second subset of components by calling a second set of subroutines from the first program;
wherein the second subset of components differs from that of at least one other member of the family of circuit boards; and
wherein the second set of subroutines differs from that of at least one other member of the family of circuit boards.

13. A telecommunications module of a family of telecommunications modules, comprising:
a processor;
a first subset of components coupled to the processor, wherein the first subset of components comprises a watchdog device and at least one communication interface;
memory coupled to the processor and having computer-usable instructions contained therein capable of causing the processor to perform a method, the method comprising:
initializing the first subset of components using a first program; and
completing the initialization of the first subset of components by calling a set of subroutines from the first program;
wherein the first subset of components and the first program are common to each member of the family of telecommunications modules; and
wherein the set of subroutines differs from that of at least one other member of the family of telecommunications modules.

14. The telecommunications module of claim 13, wherein the method further comprises:
initializing a second subset of components by calling a second set of subroutines from the first program;
wherein the second subset of components differs from that of at least one other member of the family of telecommunications modules; and
wherein the second set of subroutines differs from that of at least one other member of the family of telecommunications modules.

15. A first and second telecommunications module, each module comprising:
a processor;
a first subset of components coupled to the processor, wherein the first subset of components of each module comprise the same components;
memory coupled to the processor and having computer-usable instructions contained therein capable of causing the processor to perform a method, the method comprising:
initializing the first subset of components using a first program; and
completing the initialization of the first subset of components by calling a set of subroutines from the first program;
wherein the first program is common to both modules; and
wherein the set of subroutines of the first module differs from the set of subroutines of the second module.

16. The telecommunications module of claim 15, wherein the method further comprises:
initializing a second subset of components by calling a second set of subroutines from the first program;
wherein the second subset of components of the first module differs from the second subset of components of the second module; and
wherein the second set of subroutines of the first module differs from the second set of subroutines of the second module.

17. A method of initializing two related processor-based circuit boards, comprising:
initializing a processor on each circuit board;
running a first program on the processor of a first circuit board to initialize a first subset of components of the first circuit board; and
running the first program on the processor of a second circuit board to initialize a first subset of components of the second circuit board;
calling one or more subroutines from the first program on the processor of the first circuit board to define the functionality of the first circuit board; and
calling one or more subroutines from the first program on the processor of the second circuit board to define the functionality of the second circuit board;
wherein the first subset of components of the first circuit board contains the same components as the first subset of components of the second circuit board; and
wherein the first circuit board has a functionality different from that of the second circuit board.

18. The method of claim 17, wherein calling one or more subroutines further initializes a second subset of components of the associated circuit board.

19. The method of claim 17, further comprising:
wherein calling one or more subroutines from the first program on the processor of the first circuit board further initializes a second subset of components of the first circuit board; and
wherein the second subset of components of the first circuit board contains components not found on the second circuit board.

20. The method of claim 17, further comprising:
wherein calling one or more subroutines from the first program on the processor of the first circuit board further initializes a second subset of components of the first circuit board;
wherein calling one or more subroutines from the first program on the processor of the second circuit board further initializes a second subset of components of the second circuit board; and
wherein the second subset of components of the first circuit board contains the same components as the second subset of components of the second circuit board.
